(19) United States
(12) Patent Application Publication
(10) Pub. No.: US 2016/0040869 A1
(43) Pub. Date: Feb. 11, 2016

(54) SYSTEM AND REMOTELY CONTROLLED COMPACT CAMERA FLASH FOR CAMERA ENABLED SMART DEVICES

(71) Applicants: Alex Lukashevich, Riverwoods, IL (US); Joseph Walnes, Wilmette, IL (US)

(72) Inventors: Alex Lukashevich, Riverwoods, IL (US); Joseph Walnes, Wilmette, IL (US)

(21) Appl. No.: 14/454,999

(22) Filed: Aug. 8, 2014

(51) Int. Cl. F21V 33/00; F21L 4/00; F21V 23/04; F21V 23/00

(52) U.S. Cl. CPC F21V 33/0052; F21V 23/005; F21L 4/00; F21V 23/0407; F21W 2131/30

(57) ABSTRACT

A system and device for providing additional flash for use with an application on a camera enabled smart device includes a remotely controlled compact camera flash having a printed circuit board. The system further includes at least one light emitting diode attached to the printed circuit board. The system further includes a universal serial bus charging connection attached to the printed circuit board. The system further includes a microprocessor attached to the printed circuit board. The system further includes a wireless communicator attached to the printed circuit board. The system further includes a power source attached to the printed circuit board. The compact camera flash is controlled by the application on the smart device.

### BACKGROUND OF THE INVENTION

The present invention relates to camera flashes and, more particularly, to camera flashes for smart devices.

Currently, smart phones are equipped with underpowered forward facing flashes. Photographs that are taken under less than ideal light conditions such as at night, darker indoors conditions and the like produce pictures that lack sharpness, hide natural colors and are blurry. With the front-facing on-camera flash, light comes directly from the camera and it may cause shadows around subjects and make people look flat and shiny. In addition, because of their position close to the lens, built-in flashes often cause red eye. Off-camera flashes that are compatible with camera enabled smart phones are bulky and still have the above limitations. Current on-camera smart phones flashes are underpowered. They are front-facing and not movable. Existing flash enhancing equipment is bulky, requires wiring and requires significant set-up process including synchronization which is not practical at times. One of the reasons traditional Xenon based flash bulbs do not work with typical smart phone cameras is that they are optimized for very short exposures. Smart phone camera sensors typically use a “scanning” sensor in which the sensor scans a plane over a time period to capture the photograph. With a short exposure Xenon flash, this gives the effect of only a single bar of the photo being lit.

As can be seen, there is a need for a remotely controlled flash for camera enabled smart devices that is compact in size.

### SUMMARY OF THE INVENTION

In one aspect of the present invention, a remotely controlled compact camera flash for use with camera enabled smart devices comprises: a printed circuit board; at least one light emitting diode attached to the printed circuit board; a microprocessor attached to the printed circuit board, wherein the microprocessor comprises a wireless communicator; and a power source attached to the printed circuit board.

In another aspect of the present invention, a system for providing additional flash for use with an application on a smart device comprises: receiving a connection from a wireless communicator on a compact camera flash, wherein the compact camera flash comprises a printed circuit board; at least one light emitting diode attached to the printed circuit board; a universal serial bus charging connection attached to the printed circuit board; a microprocessor attached to the printed circuit board, wherein the microprocessor comprises a wireless communicator, a power source attached to the printed circuit board; and a back plate and a front plate, wherein the printed circuit board is sealed between the back plate and the front plate; initiating the taking of at least one photograph with a photograph application on the smart device; and activating the at least one light emitting diode to generate a flash.

These and other features, aspects and advantages of the present invention will become better understood with reference to the following drawings, description and claims.

### BRIEF DESCRIPTION OF THE DRAWINGS

FIG. 1 is a side elevation view of an exemplary embodiment of the present invention shown in use;

FIG. 2 is a front perspective view of an exemplary embodiment of the present invention;

FIG. 3 is an exploded perspective view of an exemplary embodiment of the present invention;

FIG. 4 is a front elevation view of an exemplary embodiment of the present invention; and

FIG. 5 is a bottom view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and device for providing additional flash for use with an application on a camera enabled smart device that includes a remotely controlled compact camera flash having a printed circuit board. The system further includes at least one light emitting diode attached to the printed circuit board. The system further includes a universal serial bus charging connection attached to the printed circuit board. The system further includes a microprocessor attached to the printed circuit board. The system further includes a wireless communicator attached to the printed circuit board. The system further includes a power source attached to the printed circuit board. The compact camera flash is controlled by the application on the smart device.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

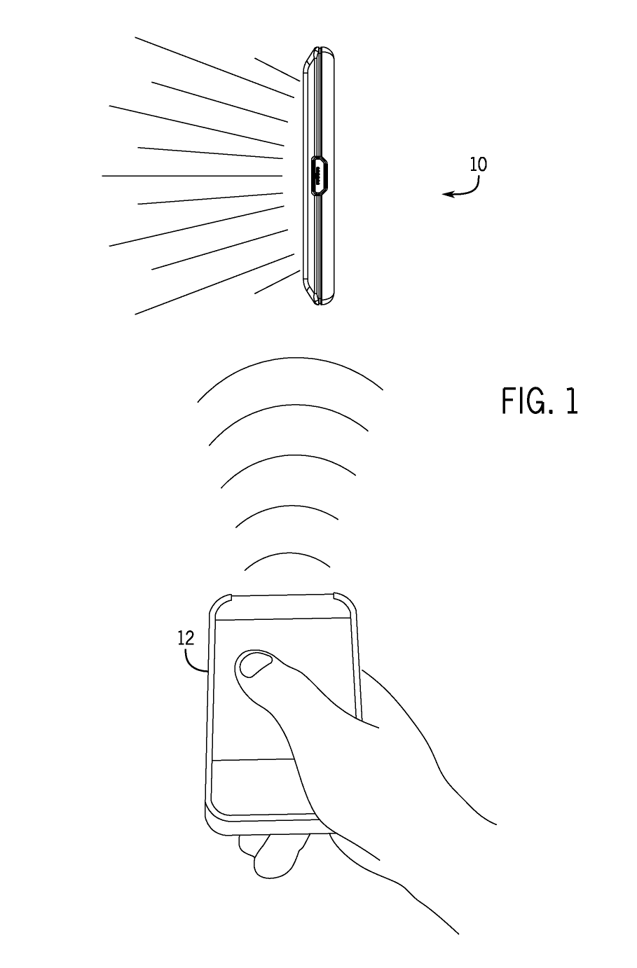

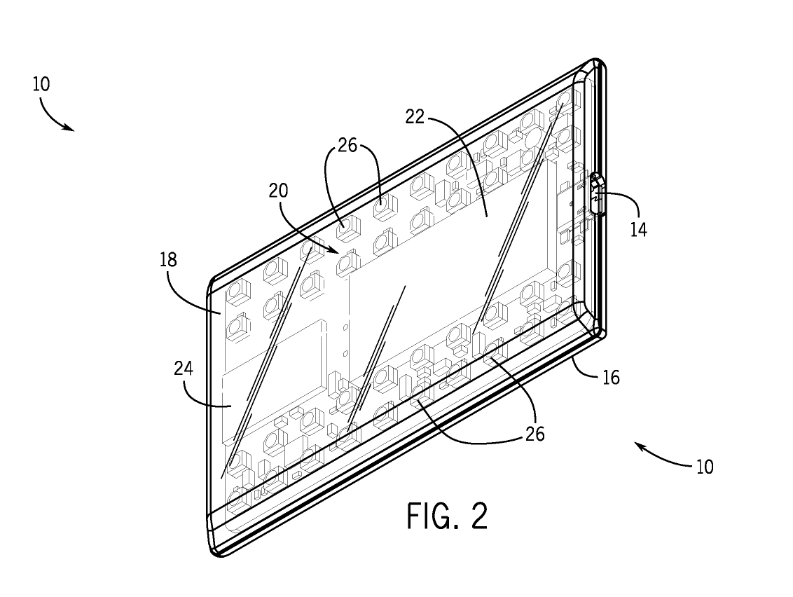

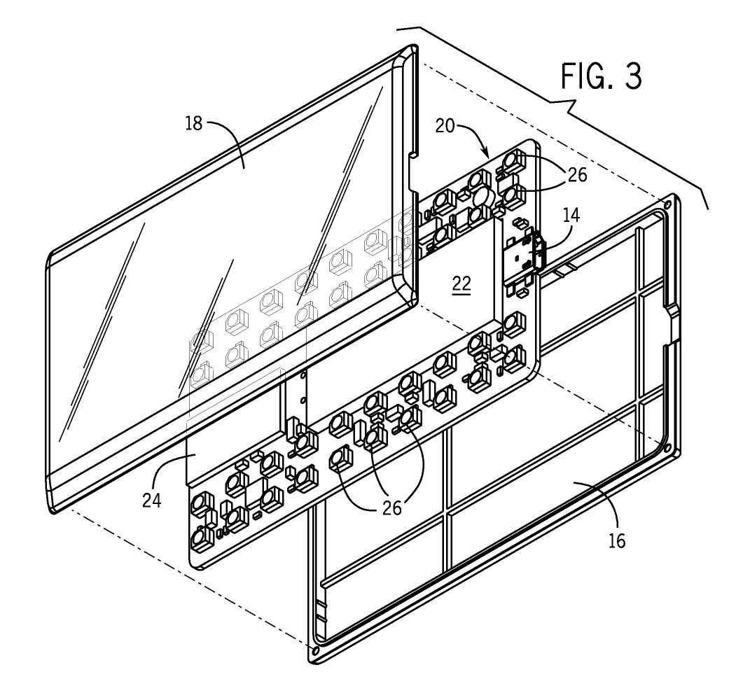

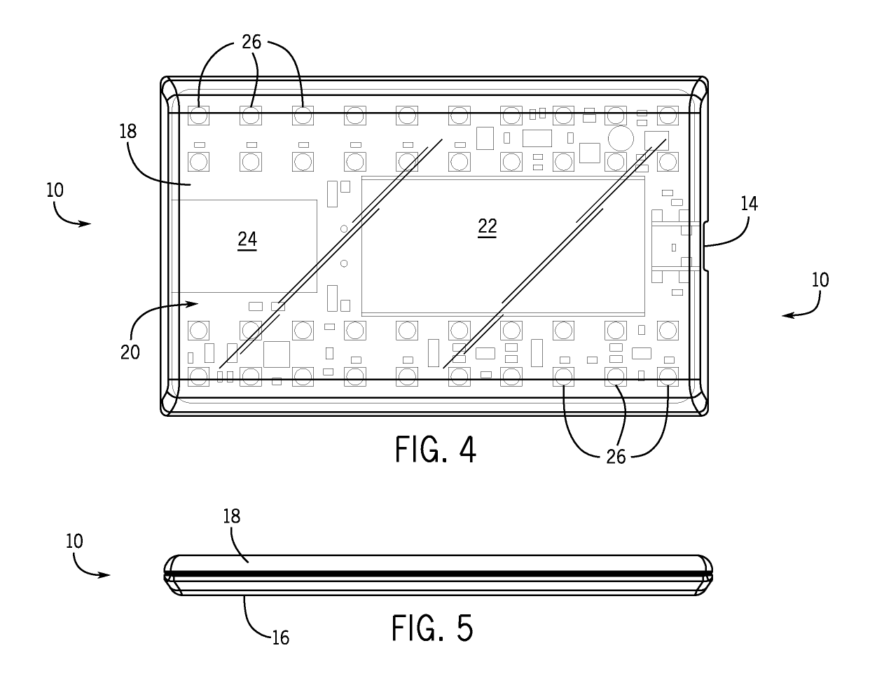

As is illustrated in FIGS. 1 through 5, a compact camera flash 10 may include a printed circuit board (PCB) 20. At least one light emitting diode (LED) 26 may be attached to the PCB 20. A universal serial bus charging connection 14 may attach to the PCB 20. The USB charging connection 14 may be used to charge a power source 22 attached to the PCB 20. The power source 22 may be a battery or the like. The battery may be a lithium polymer or the like. A microprocessor 24 may be attached to the PCB 20. The microprocessor 24 may include a wireless communicator. The wireless communicator may be Bluetooth, such as Bluetooth low energy (BLE), wifi or the like. In certain embodiments, the PCB 20 may be sealed between a front plate 18 and a back plate 16. The front plate 18 may be transparent or the like.

A method of making the compact camera flash 10 may include the following. The PCB 20 may be produced using surface mount technology. The completed PCB 20 with components may be placed inside the front plate 18 and the back plate 16. Sealing of the PCB 20 within the front plate 18 and back plate 16 may be through ultrasonic welding. The application may be developed that uses smart device application programming interface (API) to activate the LEDs 26 to generate the flash effect via the wireless communicator.

A method of using the compact camera flash 10 may include the following. An application on a smart device 12 may be used to establish a remote connection to the compact camera flash 10. Once a connection may be established using the wireless communicator, a user may be able to use a photograph application on the smart device 12 to take pictures. By pressing the “take picture” button on the smart device application, a smart device API may activate the LEDs 26 to generate a flash effect. During an inactive state, i.e. an idle mode, the application on the smart device 12 may send heartbeat signals to maintain the connection with the compact camera flash 10. Once the photograph application may be closed, the wireless communicator connection may be terminated. The compact camera flash 10 may allow a user to control angle, distance and the like from the object with the compact size and lack of attachment to the smart device 12.

In certain embodiments, the application may allow a user to control flash intensity, delay and brightness. In certain embodiments, the LEDs 26 may be a combination of warm white and cool white LEDs 26. The application may allow the user to choose the levels of each type of LED 26 to adjust the color and brightness of the light. For example, at night time, a warmer light may make the photograph look more natural, while in the day light, a cooler light may be used to remove shadows.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A remotely controlled compact camera flash for use with camera enabled smart devices comprising:
a printed circuit board;
at least one light emitting diode attached to the printed circuit board;
a microprocessor attached to the printed circuit board, wherein the microprocessor comprises a wireless communicator; and
a power source attached to the printed circuit board.

2. The compact camera flash of claim 1, further comprising the printed circuit board sealed between a back plate and a front plate.

3. The compact camera flash of claim 2, wherein the front plate is transparent.

4. The compact camera flash of claim 1, wherein the wireless communicator is a bluetooth transceiver.

5. The compact camera flash of claim 1, further comprising a universal serial bus charging connection attached to the printed circuit board.

6. The compact camera flash of claim 1, wherein the power source is a battery.

7. A system for providing additional flash for use with an application on a smart device comprising:
(a) receiving a connection from a wireless communicator on a compact camera flash, wherein the compact camera flash comprises a printed circuit board; at least one light emitting diode attached to the printed circuit board; a microprocessor attached to the printed circuit board, wherein the microprocessor comprises a wireless communicator; a power source attached to the printed circuit board; and a back plate and a front plate, wherein the printed circuit board is sealed between the back plate and the front plate;
(b) initiating the taking of at least one photograph with a photograph application on the smart device; and
(c) activating the at least one light emitting diode to generate a flash.

8. The method of claim 7, wherein the compact camera flash further comprises a universal serial bus charging connection attached to the printed circuit board.

9. The method of claim 7, wherein the wireless communicator is a bluetooth transceiver.

10. The method of claim 7, further comprising:
(d) sending heartbeat signals to the compact camera flash to maintain the connection.

11. The method of claim 10, further comprising:
(e) closing the photograph application, terminating the connection with the compact camera flash.
